(19) United States
(12) Patent Application Publication
(10) Pub. No.: US 2014/0323070 A1
(43) Pub. Date: Oct. 30, 2014

(54) AUTOMATIC FM RADIO STATION UPDATE

(71) Applicant: TEXAS INSTRUMENTS INCORPORATED, Dallas, TX (US)

(72) Inventors: Ariton E. XHAFA, Plano, TX (US); Anuj BATRA, Dallas, TX (US); Jacek STARCHURSKI, Dallas, TX (US)

(21) Appl. No.: 14/262,097

(22) Filed: Apr. 25, 2014

Related U.S. Application Data
(60) Provisional application No. 61/816,248, filed on Apr. 26, 2013.

(51) Int. Cl. H04B 1/10

(52) U.S. Cl. CPC H04B 1/1027; H04B 2001/1072
USPC 455/161.3

(57) ABSTRACT

A method comprises determining, by a radio, whether a current preferred radio station currently tuned to by a radio is experiencing a faded signal. Based on determining that the current preferred radio station is experiencing a faded signal, the method further includes automatically selecting, by the radio, a replacement preferred radio station. A radio with such capabilities is also disclosed.

### CROSS-REFERENCE TO RELATED APPLICATION

The present application claims priority to U.S. Provisional Patent Application No. 61/816,248, filed on Apr. 26, 2013 titled “Automatic FM Stations Update in Cars,” which is hereby incorporated by reference.

### BACKGROUND

Most or all cars are equipped with radios. User-preferred FM stations may be set and fixed by the owner of the car, and the owner rarely, if ever, changes them. The radios in some cars, for example, permit the car's owner to program six or more presets on the radio to different radio stations. A “preferred” radio station is the station to which the user is listening.

At times, when people travel from one city to another, say from city A to city B, the FM stations that were available in city A are not available in city B and, even if they are available in city B, they will likely not be present on the same frequencies. For example, National Public Radio (NPR) is generally available in most American cities, albeit on different frequencies from city to city. Most other radio stations are city-specific and only exist in their home city. That is, a particular radio station available in city A is simply not available in city B, although city B may have a radio station that plays the same or similar type of music. Even if one city has a radio station that is similar in terms of music type (i.e., genre), such radio stations in the two cities are likely to be on different frequencies.

A person traveling from city A to city B may try to search for similar FM stations upon entering the listening area of city B by manually causing the FM tuner to change from station to station. At each station, the driver listens to the station and determines whether that particular radio station is sufficiently similar to warrant further listening. However, on the road, this manual search and seek task may be a distraction that can lead to traffic accidents.

### SUMMARY

In some embodiments, a method comprises determining, by a radio, whether a current preferred radio station currently tuned to by a radio is experiencing a faded signal. Based on determining that the current preferred radio station is experiencing a faded signal, the method further includes automatically selecting, by the radio, a replacement preferred radio station.

In other embodiments, a radio includes a tuning circuit to tune a radio signal to any of a plurality of radio stations. The radio also includes a signal level detect to detect whether a current preferred radio station is experiencing a signal fade and to assert a signal that indicates the existence of a detected signal fade condition. A station search unit is also included to respond to the asserted signal by automatically searching for a replacement preferred radio station to the current preferred radio station experiencing signal fade.

In yet another embodiment, a radio includes a user control, a tuning circuit, and a station search unit. The tuning circuit is configured to tune a radio signal to any of a plurality of radio stations. The station search unit is configured to respond to a signal from the user control by: searching for a new radio station to the current radio station by determining whether a second radio station is within a threshold similarity of the current radio station based on content previously played on the current radio station and content played on the second radio station; and tuning to and playing content from the second radio station instead of the current radio station based on the second radio station being within a threshold similarity of the current radio station

### BRIEF DESCRIPTION OF THE DRAWINGS

For a detailed description of exemplary embodiments of the invention, reference will now be made to the accompanying drawings in which:

FIG. 1 shows a block diagram of a radio system in accordance with various embodiments;

FIG. 2 shows a method in accordance with various embodiments in which a replacement preferred radio station is automatically selected if the current preferred radio station is experiencing a faded signal;

FIG. 3 shows one embodiment of a method for automatically a replacement preferred radio station;

FIG. 4 illustrates a block diagram of a station search unit usable to automatically select a replacement preferred radio station;

FIG. 5 illustrates a table including station identifiers and metadata usable to select a preferred radio station by the station search unit of FIG. 4; and

FIG. 6 shows an embodiment of another method for automatically a replacement preferred radio station.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various embodiments are disclosed herein in which a radio is able to detect that a currently tuned radio station is experiencing signal fade and to automatically search for a replacement radio station that is sufficiently similar to the currently tuned, faded radio station. The term “automatically” means that no human involvement is needed. The principles described herein are useful for a variety of radio types such as portable radios (e.g., a radio in a vehicle). Cars of course may leave a given radio listening area and drive towards another listening area. A car may be driven from one city to another. The ability of the car's radio to automatically search for a suitable replacement radio station permits the listener to continue to enjoy the same or similar listening experience.

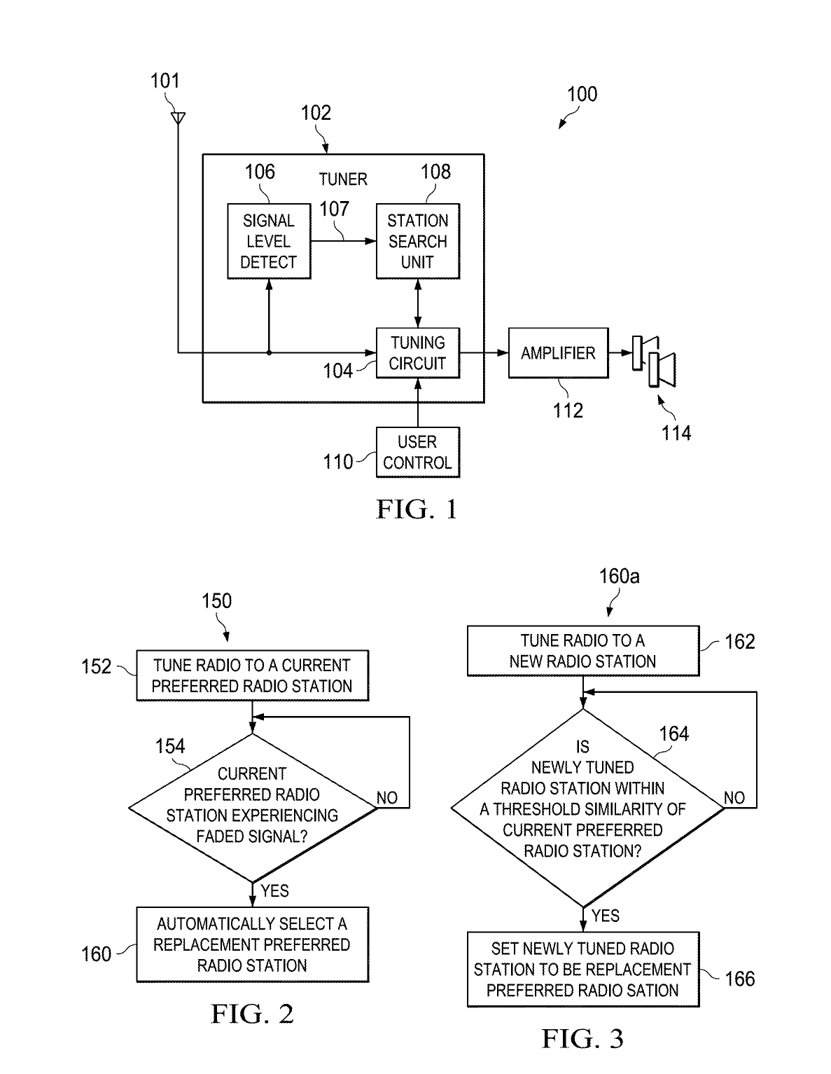

FIG. 1 illustrates a radio 100 in accordance with various embodiments. Radio 100 may include a tuner 102, user controls 110, and an amplifier 112. The amplifier 112 may drive one or more speakers 114. The radio 100 may be a radio that is built-in to a car or may be any other type of portable radio.

The tuner 102 includes a tuning circuit 104. An antenna 101 receives radio signals and provides those signals to the tuning circuit. The user controls 110 may include buttons or other types of user activatable controls to permit a user to tune the radio to a desired radio station. Once the radio is tuned to a desired radio station, the amplifier 112 amplifies the signal and provides the amplified signal to the speakers 114. The amplifier 112 may also include or couple to filter and equalization circuitry.

The tuner 102 also includes a signal level detect 106 and a station search unit 108. The signal level detect 106 determines when the received signal level from the antenna 101 has fallen below a threshold. As the radio moves away from the source of the radio broadcast, the signal will begin to fade. The signal level detect 106 detects such a signal fade condition. Typically during the signal fade condition, the signal is lost for a relatively long duration but may become stronger for a shorter duration

The currently tuned radio station, which may be experiencing a faded signal, is referred to herein as the “current preferred” radio station. It is the radio station that was playing on the radio when the faded signal condition was detected. When a signal fade condition is detected for the current preferred radio station, the signal level detect 106 asserts a signal 107 to the station search unit 108. The station search unit 108 responds to the asserted signal by automatically selecting a replacement preferred radio station for the current radio station. Various embodiments of how the station search unit 108 selects a replacement preferred radio station are provided below.

FIG. 2 shows a method in accordance with various embodiments. At 152, the user has tuned the radio to a current preferred radio station. At 154, the signal level detect 106 determines whether the received signal of the current preferred radio station is experiencing a faded signal condition. This operation may be performed by the signal level detect 106 determining whether the received signal of the current preferred radio station has dropped below a predetermined threshold or whether the signal is received intermittently. Operation 154 is performed repeatedly (e.g., continuously or periodically) until a faded signal condition is in fact detected. When that happens, at 160, the station search unit 108 is commanded to begin the search for a suitable replacement preferred station.

A suitable replacement preferred station is a radio station that plays the same or similar type of music as the current preferred radio station. For example, a radio station may be a suitable replacement if it plays the same or similar genre of music as the current preferred radio station.

Many radio stations broadcast not just the audio to be played back on the users' radios, but also metadata that can be decoded and displayed on the user's radios or displays built into the vehicle. The metadata may include song title, album name, artist name, etc. The tuning circuit 104 or other logic in the tuner 102 may store such metadata information for the past in songs of the current preferred radio station. The value of n is an integer greater than 0 (1, 2, 3, . . . ). This stored metadata information can be used by the station search unit 108 to determine if a new radio station plays similar enough music to the current preferred radio station to be determined to be a suitable replacement for the current preferred radio station. Other radio stations may be replacement radio stations to the current preferred radio station but are not replacement “preferred” radio stations because their songs are not similar enough to the songs previously played on the current preferred radio station.

FIG. 3 illustrates one embodiment of operation 160 (shown in FIG. 3 as method 160a) in which a replacement preferred radio station is automatically selected. This method may be performed by the station search unit 108. At 162, the station search unit 108 automatically causes the tuning circuit 104 to tune to a new radio station. The new radio station may be the next radio station frequency in an upward or downward direction on the radio “dial” from the current radio station's frequency.

As the new radio station's signal is received, the tuning circuit 104 retrieves and provides its metadata to the station search unit 108. The station search unit 108 compares the new radio station's metadata to the previously stored metadata from the current preferred radio station. At 164, the station search unit 108 determines whether the newly tuned radio station is within a threshold similarity of the current preferred radio station. This determination can be performed by determining whether the song currently playing on the new radio station is listed in the previously stored metadata of the current preferred radio station.

If the song currently playing on the new radio station is listed in the previously stored metadata of the current preferred radio station, then the newly tuned radio station may be set to be the replacement preferred radio station and the search process ends. If, however, the currently playing on the new radio station is not listed in the previously stored metadata of the current preferred radio station, then control loops back to 162 and the station search unit 108 causes the tuning circuit 104 to tune to yet another new radio station. The process repeats until a suitable replacement preferred radio station is found as described above. Thus, if the radio is tuned from the current preferred radio station to a second radio station and that second radio station is not within a threshold similarity of the current preferred radio station, the radio is further tuned to a third radio station for an assessment of that radio station.

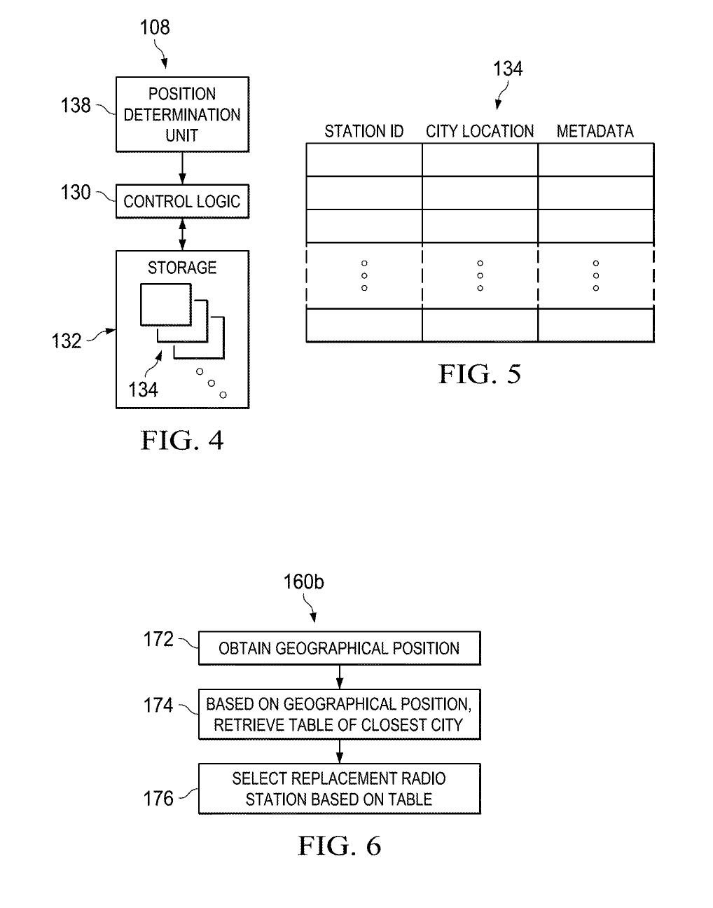

FIG. 4 shows an illustrative implementation of the station search unit 108. In FIG. 4, the station search unit includes control logic 130 that couples to a position determination 138 and storage 132. The position determination unit 138 may include a Global Positioning System (GPS) receiver or other type of device that can ascertain the radio's geographic position. The position determination unit 138 (e.g., GPS receiver) may be included as part of the radio 100 itself or may be separate from, but accessible to, the radio. For example, the position determination unit 138 may be the GPS system included in the vehicle or may be the GPS receiver included in most smart phones and accessible to the radio 100 via a docking port or via a wireless communication link (e.g., Bluetooth).

The storage 132 includes any suitable type of non-volatile storage device (e.g., random access memory, flash storage, a hard drive, etc.). The storage 132 may be included as part of the tuner 102 or may be separate from the tuner. If separate from the tuner, the storage 132 may be included as part of the vehicle or as part of a smart phone in the vehicle (accessible via a dock or wireless interface such as Bluetooth).

The storage device 132 includes a plurality of tables 134. Each table 134 corresponds to a different city and includes the city's location (e.g., the longitude and latitude coordinate of the center/downtown position of the city), and for each radio station in that city, a radio station identifier and metadata for the radio station.

FIG. 5 illustrates a format of a table 134 in one embodiment. The table station identifier (ID) may include any suitable identifier for the radio station such as its call letters (e.g., KUHF). The metadata for the radio station may specify genre (news, rock, country, classical, etc.) or other type of radio station information.

FIG. 6 provides another embodiment for operation 160 (shown in FIG. 6 as method 160b) based on the use of the position determination unit 138. At 172, the method includes obtaining the geographical position of the radio. This operation uses the position determination unit 138 which may be a GPS receiver as noted above, and may be the GPS location of a car containing the radio. At 174, based on the obtained geographical position of the radio, the method further includes retrieving from storage 132 a table of a city that is closest to the radio's geographical position.

The method 160b in FIG. 6 then includes (at 176) selecting the replacement preferred radio station based on the retrieved table. This operation may include examining the metadata in each entry in the retrieved table and selecting the radio station of the entry whose metadata (e.g., genre) matches that of the current preferred radio station. In some embodiments, the metadata in the table may specify for a given radio station that the station is National Public Radio (NPR). If the current preferred radio station was also the NPR affiliate in the former city, then the station search unit 108 would select the NPR affiliate from the table 134 in the closest city to the user's current location. Otherwise, the station search unit 108 will select a radio station with the same genre of content (classical, news, country, etc.).

In the embodiments provided above, the tuner 102 begins to search for a replacement radio station when the current preferred radio station experiences a signal fade condition indicative of the tuner exiting the listening range of that station's broadcast signal. In other embodiments, the tuner may search for a replacement station even in the absence of a signal fade condition. For example, while tuned to a particular current radio station, a user may cause the tuner to switch to another radio station that plays similar content to the current radio station (e.g., to avoid listening to an advertisement). In this way, the tuner may essentially assemble a group of two or more related stations and switch between such stations, preferably on command by the user (e.g., by activating user control 110). More than two radio stations may be designated as suitable alternatives.

In some embodiments, the group of radio stations is determined a priori as being suitable alternatives and the carrier frequencies or other identifiers of such stations may be stored in the station search unit. The identity of the stations may be programmed into the station search unit through use of the user control or via a wireless signal received by antenna 101. In other embodiments, when the user activates user control 110 to switch from the current radio station to a new but similar radio station, the tuner 102 begins to search for a new station much in the same as described above when experiencing a signal fade condition.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
determining, by a radio, whether a current preferred radio station currently tuned to by a radio is experiencing a faded signal;
based on determining that the current preferred radio station is experiencing a fade signal, automatically selecting, by the radio, a replacement preferred radio station.

2. The method of claim 1 wherein selecting the replacement preferred radio station includes:
tuning the radio from the current preferred radio station to a second radio station;
determining, by the radio, whether the second radio station is within a threshold similarity of the current preferred radio station based on a song previously played on the current preferred radio station and a song played on the second radio station;
setting the second station to be the replacement preferred radio station based on the second radio station being within the threshold similarity of the current preferred radio station; and
based on the second radio station not being with a threshold similarity, not setting the second station to the replacement preferred radio station and instead automatically turning the radio to a third station.

3. The method of claim 2, further comprising:
determining, by the radio, whether the third radio station is within a threshold similarity to the current preferred radio station based on a song previously played on the current preferred radio station and a song played on the third radio station; and
setting the third station to be the replacement preferred radio station based on the third radio station being within the threshold similarity to the current preferred radio station.

4. The method of claim 2, wherein determining whether the second radio station is within the threshold similarity of the current preferred radio station includes determining whether the song previously played on the current preferred radio station and the song on the second radio station are the same.

5. The method of claim 2, wherein determining whether the second radio station is within the threshold similarity of the current preferred radio station includes determining whether a plurality of songs on the second radio station are the same as a plurality of songs previously played on the current preferred radio station.

6. The method of claim 5 further including a user of the radio specifying how many songs are to be included in each plurality of songs.

7. The method of claim 1 wherein selecting the replacement preferred radio station includes:
obtaining a geographical position of the radio;
based on the obtained geographical position of the radio, retrieving a table of a city that is closest to the radio's geographical position, the table indicating which radio stations are broadcast for the corresponding city; and
selecting the replacement preferred radio station based on the table.

8. The method of claim 7 wherein the table includes radio station identifiers and for each radio station identifier, the table includes metadata of the corresponding radio station, the metadata including genre information, and wherein selecting the replacement preferred radio station includes selecting the replacement preferred radio station based on the metadata in the table.

9. A radio, comprising:
a tuning circuit to tune a radio signal to any of a plurality of radio stations;
a signal level detect to detect whether a current preferred radio station is experiencing a signal fade and to assert a signal that indicates the existence of a detected signal fade condition; and
a station search unit to respond to the asserted signal by automatically searching for a replacement preferred radio station to the current preferred radio station experiencing signal fade.

10. The radio of claim 9 wherein the station search unit is to search for the replacement preferred radio station by:
automatically causing the tuning circuit to tune from the current preferred radio station to a second radio station, a second song being played on the second radio station;
determining whether the second radio station is within a threshold similarity to the current preferred radio station;
setting the second station to be the replacement preferred radio station based on the second radio station being within the threshold similarity to the current preferred radio station; and
based on the second radio station not being with the threshold similarity, causing the tuning circuit to tune from the second radio station to a third station, a third song being played on the third radio station.

11. The radio of claim 10 wherein the station search unit is to search for the replacement preferred radio station by
determining whether the third radio station is within a threshold similarity to the current preferred radio station; and
setting the third station to be the replacement preferred radio station based on the third radio station being within the threshold similarity to the current radio station.

12. The radio of claim 9 wherein the station search unit is to search for the replacement preferred radio station by:
accessing a position determination unit to obtain a geographical position of the radio;
based on the obtained geographical position of the radio, retrieving a table of a city that is closest to the radio's geographical position, the table indicating which radio stations are broadcast for the corresponding city; and
selecting the replacement preferred radio station based on the table.

13. The radio of claim 12 wherein the radio includes the position determination unit.

14. The radio of claim 12 wherein the table includes radio station identifiers and for each radio station identifier, the table includes metadata of the corresponding radio station, the metadata including genre information, and wherein selecting the replacement radio station includes selecting the replacement preferred radio station based on the metadata in the table.

15. A radio, comprising:
a user control;
a tuning circuit to tune a radio signal to any of a plurality of radio stations; and
a station search unit to respond to a signal from the user control by:
searching for a new radio station to the current radio station by determining whether a second radio station is within a threshold similarity of the current radio station based on content previously played on the current radio station and content played on the second radio station; and
tuning to and playing content from the second radio station instead of the current radio station based on the second radio station being within a threshold similarity of the current radio station.
